(19) United States
(12) Patent Application Publication
(10) Pub. No.: US 2015/0093508 A1
(43) Pub. Date: Apr. 2, 2015

(54) COMPOSITION FOR PATTERN FORMATION AND PATTERN-FORMING METHOD

(71) Applicant: JSR CORPORATION, Tokyo (JP)

(72) Inventors: Tomoki NAGAI, Tokyo (JP); Shinya Minegishi, Tokyo (JP); Takuo Sone, Tokyo (JP); Yuji Namie, Tokyo (JP)

(73) Assignee: JSR CORPORATION, Tokyo (JP)

(21) Appl. No.: 14/566,841

(22) Filed: Dec. 11, 2014

Related U.S. Application Data
(63) Continuation of application No. PCT/JP2013/067420, filed on Jun. 25, 2013.

(30) Foreign Application Priority Data
Jun. 29, 2012 (JP) 2012-147712
Oct. 12, 2012 (JP) 2012-226521

(51) Int. Cl. C09D 153/00

(52) U.S. Cl. CPC C09D 153/00
USPC 427/271; 524/547; 524/562; 524/317

(57) ABSTRACT

A composition for pattern formation includes a block copolymer that includes a block represented by formula (I) and a block represented by formula (II). R¹ and R³ each independently represent a hydrogen atom, a methyl group, a fluorine atom or a trifluoromethyl group. R² represents a monovalent organic group. R⁴ represents a hydrocarbon group having a valency of (1+b) and having 1 to 5 carbon atoms. R⁵ represents a monovalent group having a hetero atom. m and n are each independently an integer of 10 to 5,000. a is an integer of 0 to 5. b is an integer of 1 to 3.

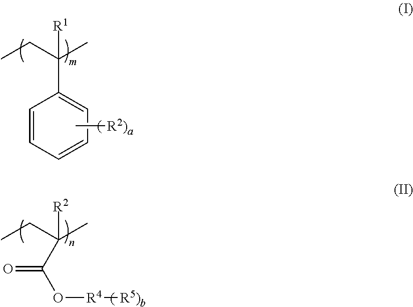

### CROSS-REFERENCE TO RELATED APPLICATIONS

The present application is a continuation application of International Application No. PCT/JP2013/067420, filed Jun. 25, 2013, which claims priority to Japanese Patent Application No. 2012-147712, filed Jun. 29, 2012, and to Japanese Patent Application No. 2012-226521, filed Oct. 12, 2012. The contents of these applications are incorporated herein by reference in their entirety.

### BACKGROUND OF THE INVENTION

1. Field of the Invention

The present invention relates to a composition for pattern formation, and a pattern-forming method.

2. Discussion of the Background

Miniaturization of various types of electronic device structures such as semiconductor devices and liquid crystal devices has been accompanied by demands for miniaturization of patterns in lithography processes. At present, although fine patterns having a line width of about 90 nm can be formed using, for example, an ArF excimer laser, further finer pattern formation is required.

To meet the demands described above, some pattern-forming methods in which a phase separation structure by directed self-assembling, as generally referred to, is utilized that spontaneously forms an ordered pattern have been proposed. For example, an ultrafine pattern-forming method by directed self-assembling has been known in which a block copolymer is used which is obtained by copolymerizing a monomer compound having one property with a monomer compound having a property that is distinct from the one property (see Japanese Unexamined Patent Application, Publication No. 2008-149447, Japanese Unexamined Patent Application (Translation of PCT Application), Publication No. 2002-519728, and Japanese Unexamined Patent Application, Publication No. 2003-218383). According to this method, annealing of a composition containing the block copolymer results in a tendency of clustering of polymer structures having the same property, and thus a pattern can be formed in a self-aligning manner. In addition, a method of forming a fine pattern by permitting directed self-assembling of a composition that contains a plurality of polymers having properties that are different from one another has been also known (see US Patent Application, Publication No. 2009/0214823, and Japanese Unexamined Patent Application, Publication No. 2010-58403).

### SUMMARY OF THE INVENTION

According to one aspect of the present invention, a composition for pattern formation includes a block copolymer. The block copolymer includes a block represented by formula (I) and a block represented by formula (II).

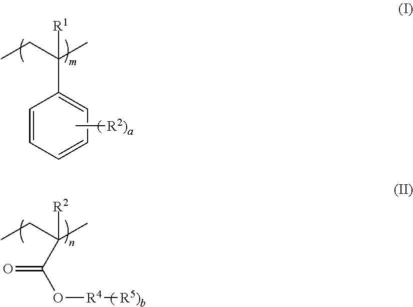

In the formulae (I) and (II), R¹ and R³ each independently represent a hydrogen atom, a methyl group, a fluorine atom or a trifluoromethyl group; R² represents a monovalent organic group; R⁴ represents a hydrocarbon group having a valency of (1+b) and having 1 to 5 carbon atoms; R⁵ represents a monovalent group having a hetero atom; m and n are each independently an integer of 10 to 5,000; a is an integer of 0 to 5; and b is an integer of 1 to 3, wherein in a case in which a and b are each 2 or greater, a plurality of R²s are each identical or different with each other, and a plurality of R⁵s are each identical or different with each other.

According to another aspect of the present invention, a pattern-forming method includes:

applying the composition directly or indirectly on a substrate such that a directed self-assembling film including a phase separation structure is provided. The phase separation structure includes a plurality of phases each of which is separately arranged. A part of the plurality of phases of the directed self-assembling film is removed such that a pattern is formed.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 shows a schematic view illustrating one example of a state after providing an underlayer film on a substrate in the pattern-forming method according to an embodiment of the present invention;

FIG. 2 shows a schematic view illustrating one example of a state after forming a prepattern on the underlayer film in the pattern-forming method according to the embodiment of the present invention;

FIG. 3 shows a schematic view illustrating one example of a state after coating a composition for pattern formation on a region surrounded by the prepattern on the underlayer film in the pattern-forming method according to the embodiment of the present invention;

FIG. 4 shows a schematic view illustrating one example of a state after providing the directed self-assembling film on a region surrounded by the prepattern on the underlayer film in the pattern-forming method according to the embodiment of the present invention; and

FIG. 5 shows a schematic view illustrating one example of a state after removing a part of phases of the directed self-assembling film and the prepattern in the pattern-forming method according to the embodiment of the present invention.

### DESCRIPTION OF THE EMBODIMENTS

According to a first embodiment of the invention made for solving the aforementioned problems, a composition for pattern formation contains a block copolymer (hereinafter, may be also referred to as “(A) block copolymer” or “block copolymer (A)”) that includes a block represented by the following formula (I) (hereinafter, may be also referred to as “block (I)”), and a block represented by the following formula (II) (hereinafter, may be also referred to as “block (II)”).

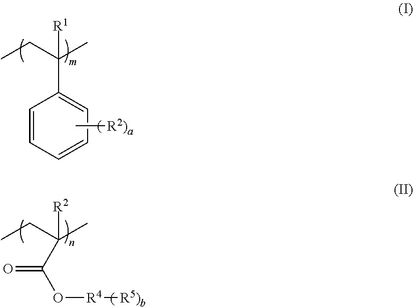

In the formulae (I) and (II), R¹ and R³ each independently represent a hydrogen atom, a methyl group, a fluorine atom or a trifluoromethyl group; R² represents a monovalent organic group; R⁴ represents a hydrocarbon group having a valency of (1+b) and having 1 to 5 carbon atoms; R⁵ represents a monovalent group having a hetero atom; m and n are each independently an integer of 10 to 5,000; a is an integer of 0 to 5; and b is an integer of 1 to 3, wherein in a case in which a and b are each 2 or greater, a plurality of R²s are each identical or different with each other, and a plurality of R⁵s are each identical or different with each other.

It is preferred that the composition for pattern formation further contains a solvent (hereinafter, may be also referred to as “(B) solvent(s)” or “solvent (B)”).

Also, in the above formula (II), it is preferred that R⁵ represents —OSiR⁶₃, —SiR⁶₃, —OH, —NH₂, —OSiH₃, —COOH, —COOR⁶ or —COR⁶, wherein R⁶ represents a monovalent hydrocarbon group having 1 to 5 carbon atoms, or a monovalent silicon-containing group having 1 to 5 silicon atoms, wherein in a case in which R⁶ is present in a plurality of number, a plurality of R⁶s are identical or different.

Furthermore, it is preferred that the block copolymer (A) has a hetero atom-containing group (hereinafter, may be also referred to as “group (α)” on at least one end of the main chain.

According to a second embodiment of the present invention made for solving the aforementioned problems, a pattern-forming method includes the steps of:

providing a directed self-assembling film having a phase separation structure on the upper face side of a substrate using the composition for pattern formation of the first embodiment of the present invention; and

removing a part of phases of the directed self-assembling film.

It is preferred that the pattern-forming method according to the another embodiment of the present invention further includes before the step of providing the directed self-assembling film:

providing an underlayer film on the substrate; and

forming a prepattern on the underlayer film,

and

in the step of providing the directed self-assembling film, the directed self-assembling film is provided in a region compartmentalized by the prepattern on the underlayer film,

and that the method further includes after the step of providing the directed self-assembling,

removing the prepattern.

The pattern obtained by the pattern-forming method according to the another embodiment of the present invention is preferably a line-and-space pattern or a hole pattern. When the line-and-space pattern or the hole pattern is formed according to the pattern-forming method, a finer desired pattern can be formed.

According to the embodiment s of the present invention, a composition for pattern formation that enables a sufficiently fine pattern to be formed, and a pattern-forming method in which the composition is used are provided. The composition for pattern formation and the pattern-forming method of the embodiments of the present invention can be suitably used for lithography processes in manufacture of various types of electronic devices such as semiconductor devices and liquid crystal devices for which further miniaturization is demanded.

Hereinafter, embodiments of the composition for pattern formation, and the pattern-forming method of the present invention will be described in detail.

### Composition for Pattern Formation

Directed self-assembling as referred to means a phenomenon of spontaneously constructing a tissue or structure without resulting from only the control from an external factor. According to the embodiment of the present invention, a film having a phase separation structure by directed self-assembling (i.e., directed self-assembling film) is formed by coating a composition for pattern formation on a substrate, and a part of phases in the directed self-assembling film are removed, thereby enabling a pattern to be formed.

The composition for pattern formation according to the embodiment of the present invention contains (A) a block copolymer that includes a block (I) and a block (II). Since the composition for pattern formation has two types of blocks having a great λ parameter, phase separation is likely to occur, whereby a pattern having a sufficiently fine microdomain structure can be formed. The composition for pattern formation may contain optional components such as (B) a solvent and a surfactant in addition to the block copolymer (A), within a range not leading to impairment of the effects of the present invention. Hereinafter, each component will be explained in detail.

### (A) Block Copolymer

The block copolymer (A) includes the block (I) and the block (II). The block (I) is constituted with a structural unit derived from a styrene compound, and the block (II) is constituted with a structural unit derived from a (meth)acrylic acid ester that includes a group having a hetero atom.

The block copolymer (A) has a structure in which a plurality of blocks at least including the block (I) and the block (II) are linked. Each of the blocks has a chain structure of units derived from one type of monomer, in principle. When the block copolymer (A) having such a plurality of blocks is dissolved in an appropriate solvent, the same type of blocks are aggregated to one another, and thus phases configured with the same type of the blocks are formed. In this step, it is presumed that a phase separation structure having an ordered pattern in which different types of phases are periodically and alternately repeated can be formed since the phases formed with different types of the blocks are not admixed with each other.

The block copolymer (A) may be composed only of the block (I) and the block (II), or may further include in addition to the block (I) and the block (II), any block other than these.

The block copolymer (A) composed only of the block (I) and the block (II) is exemplified by diblock copolymers, triblock copolymers, tetrablock copolymers, and the like constituted with the block (I) and the block (II). Of these, in light of a capability of easy formation of a pattern having a fine microdomain structure desired, diblock copolymers and triblock copolymers are preferred, and diblock copolymers are more preferred.

The block (I) is represented by the above formula (I).

In the above formula (I), R¹ represents a hydrogen atom, a methyl group, a fluorine atom or a trifluoromethyl group, and preferably represents a hydrogen atom or a methyl group.

R² represents a monovalent organic group, which is exemplified by a carboxyl group, a cyano group, a hydrocarbon group having 1 to 20 carbon atoms, and the like. Examples of the hydrocarbon group having 1 to 20 carbon atoms include: alkyl groups such as a methyl group, an ethyl group, a n-propyl group, an i-propyl group, a n-butyl group and a t-butyl group; alkenyl groups such as an ethenyl group, a 2-propenyl group, a 3-butenyl group, a 4-pentenyl group, a 5-hexenyl group and a 7-octenyl group; cycloalkyl groups such as a cyclopropyl group, a cyclobutyl group, a cyclopentyl group and a cyclohexyl group; aryl groups such as a phenyl group and a naphthyl group; aralkyl groups such as a benzyl group and a phenethyl group; and the like. Of these, alkyl groups and alkenyl groups are preferred.

Further, m is an integer of 10 to 5,000, and a is an integer of 0 to 5, preferably 0 or 1.

Specific preferred examples of the block (I) include a polystyrene block, a poly(α-methylstyrene) block and a poly(4-(7′-octenyl)styrene) block. Such a block (I) can be prepared by polymerizing a corresponding styrene monomer.

The block (II) is represented by the above formula (II).

In the above formula (II), R³ represents a hydrogen atom, a methyl group, a fluorine atom or a trifluoromethyl group, and preferably represents a hydrogen atom or a methyl group. R⁴ represents a hydrocarbon group having a valency of (1+b) and having 1 to 5 carbon atoms, which is exemplified by, in a case in which b is 1, alkanediyl groups such as a methanediyl group, an ethanediyl group and a n-propanediyl group; cycloalkanediyl groups such as a cyclobutanediyl group and a cyclopentanediyl group; and the like. Of these, R⁴ represents preferably an alkanediyl group, more preferably a methanediyl group or an ethanediyl group, and still more preferably an ethanediyl group. R⁵ represents a monovalent group having a hetero atom, preferably —OSiR⁶₃, —SiR⁶₃, —OH, —NH₂, —OSiH₃, —COOH, —COOR⁶ or —COR⁶, more preferably —OSiR⁶₃, —SiR⁶₃, —OSiH₃, —COOR⁶ or —COR⁶, and particularly preferably —OSiR⁶₃, wherein R⁶ preferably represents a monovalent hydrocarbon group having 1 to 5 carbon atoms or a monovalent silicon-containing group having 1 to 5 silicon atoms, and in a case in which R⁶ is present in a plurality of number, R⁶s may be identical or different, and may be include both a hydrocarbon group and a silicon atom-containing group. Examples of the monovalent hydrocarbon group having 1 to 5 carbon atoms include groups having 1 to 5 carbon atoms among the groups exemplified as the hydrocarbon group which may be represented by R² above, and the like. Of these, alkyl groups are preferred, and a methyl group is more preferred. Examples of the monovalent silicon-containing group having 1 to 5 silicon atoms include trialkylsiloxy groups, trialkylsilyl groups and the like, and trialkylsiloxy groups are preferred and a trimethyl siloxy group is more preferred. According to the composition for pattern formation, due to the aforementioned groups represented by R⁵ and R⁶, formation of a pattern having a still finer microdomain structure is enabled.

In addition, n is an integer of 10 to 5,000; b is an integer of 1 to 3, and preferably 1. In a case in which b is 2 or greater, a plurality of R⁵s are identical or different.

Specific preferred examples of the block (II) include a poly(hydroxyethyl methacrylate) block, a poly(hydroxyethyl acrylate) block, a poly(hydroxypropyl acrylate) block, a poly(trimethylsiloxyethyl methacrylate) block and a poly(trimethylsiloxyethyl acrylate) block. The block (II) can be prepared by polymerizing a corresponding (meth)acrylic acid ester.

Examples of the other block include blocks constituted with a poly((meth)acrylic acid ester) other than the block (II), blocks constituted with polyvinyl acetal, blocks constituted with polyurethane, blocks constituted with polyurea, blocks constituted with polyimide, blocks constituted with polyamide, blocks constituted with a structural unit derived from an epoxy compound, blocks constituted with a novolak type phenol, blocks constituted with polyester, and the like. The percentage content of the structural unit constituting the other block in the block copolymer (A) is preferably no greater than 10 mol % with respect to the total structural units in the copolymer.

The molar ratio of the structural unit constituting the block (I) to the structural unit constituting the block (II) in the block copolymer (A) is preferably no less than 10/90 and no greater than 90/10, more preferably no less than 20/80 and no greater than 80/20, and still more preferably no less than 30/70 and no greater than 70/30.

When the ratio of the percentage content of (mol %) of each block of the block copolymer (A) falls within the above range, the composition for pattern formation enables a pattern having a finer microdomain structure to be formed.

The block copolymer (A) can be synthesized by preparing the block (I) and the block (II), and further as needed, the other block in a desired order, followed by, as needed, subjecting its polymerization end to a treatment with an appropriate end treatment agent. Due to the block copolymer (A) having the hetero atom-containing group (α) on at least one end of the main chain thereof, phase separation is more likely to occur.

Although the hetero atom in the hetero atom-containing group (α) is not particularly limited, the hetero atom is preferably an oxygen atom, a nitrogen atom, a sulfur atom, a phosphorus atom, a tin atom or a silicon atom, more preferably an oxygen atom, a nitrogen atom or a sulfur atom, and still more preferably an oxygen atom.

The group (α) is preferably a group represented by the following formula (1).

*—R⁷—OH (1)

In the above formula (1), R⁷ represents a divalent organic group having 1 to 30 carbon atoms; “*” denotes a site that binds to a carbon atom at the end of the main chain of the polymer in the block copolymer (A).

The divalent organic group having 1 to 30 carbon atoms represented by R⁷ is exemplified by: a divalent chain hydrocarbon group having 1 to 30 carbon atoms; a divalent alicyclic hydrocarbon group having 3 to 30 carbon atoms; a divalent aromatic hydrocarbon group having 6 to 30 carbon atoms; a divalent group (x) that includes any one of these divalent chain hydrocarbon group, divalent alicyclic hydrocarbon group and divalent aromatic hydrocarbon group, and further includes a group having a hetero atom between adjacent two carbon atoms; a group (y) obtained by substituting a part or all of hydrogen atoms included in the divalent chain hydrocarbon group, the divalent alicyclic hydrocarbon group, the divalent aromatic hydrocarbon group and the group (x) with a substituent; and the like.

Examples of the divalent linear hydrocarbon group having 1 to 30 carbon atoms include a methanediyl group, an ethanediyl group, a n-propanediyl group, an i-propanediyl group, a n-butanediyl group, an i-butanediyl group, a n-pentanediyl group, an i-pentanediyl group, a n-hexanediyl group, an i-hexanediyl group, and the like. Of these, in light of easier occurrence of phase separation of the composition for pattern formation, a methanediyl group, an ethanediyl group, an i-propanediyl group and an i-butanediyl group are preferred, and an i-butanediyl group is more preferred.

Examples of the divalent alicyclic hydrocarbon group having 3 to 30 carbon atoms include a cyclopropanediyl group, a cyclobutanediyl group, a cyclopentanediyl group, a cyclohexanediyl group, a cyclooctanediyl group, a norbornanediyl group, an adamantanediyl group, and the like.

Examples of the divalent aromatic hydrocarbon group having 6 to 30 carbon atoms include a phenylene group, a naphthylene group, an anthrylene group, and the like.

Examples of the hetero atom in the group (x) include those similar to the atoms exemplified as the hetero atom which may be included in the group (α), and the like. Examples of the divalent group that includes any one of the divalent chain hydrocarbon group, divalent alicyclic hydrocarbon group and divalent aromatic hydrocarbon group, and further includes a group having a hetero atom between adjacent two carbon atoms include groups that include a group having at least one hetero atom such as —O—, —COO—, —OCO—, —NO— or —NH— between adjacent two carbon atoms of the above hydrocarbon groups, and the like.

Examples of the group (x) include a 3-butoxypropane-1,2-diyl group, a 2-butoxybutane-2,4-diyl group, a 3-octyloxypropane-1,2-diyl group, a 3-hexyloxy-1,2-diyl group, and the like.

Examples of the group (y) include a 1-cyanoethane-1,2-diyl group, a di(4-diethylaminophenyl)methane-1,1-diyl group, a 3-dimethylaminopropyl-2,2-diyl group, a 3-dimethylaminopropyl-1,2-diyl group, a dimethylaminomethane-1,1-diyl group, a carbonyl group, and the like.

Examples of the group (α) include groups include groups represented by the following formulae, and the like.

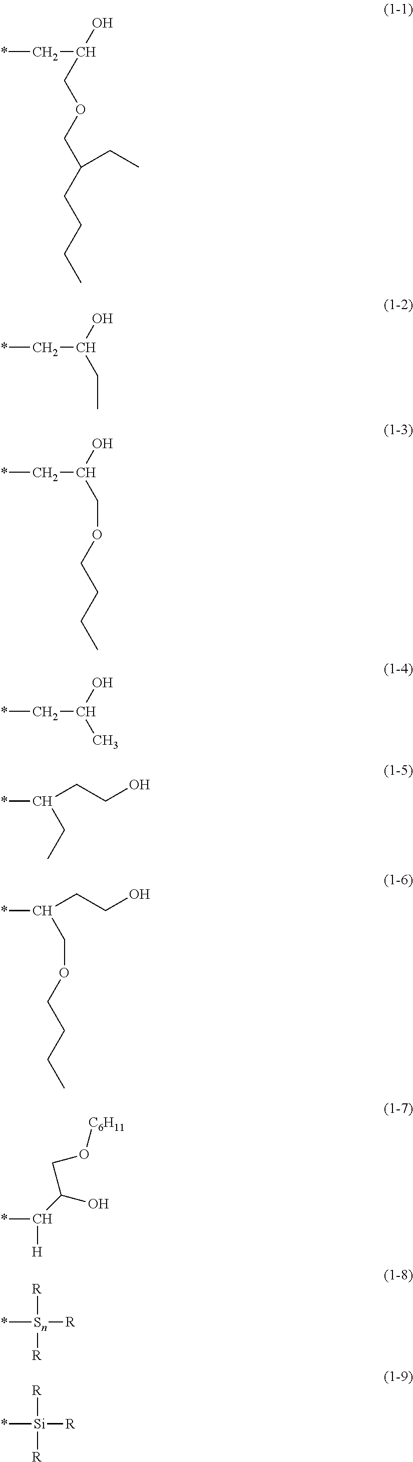

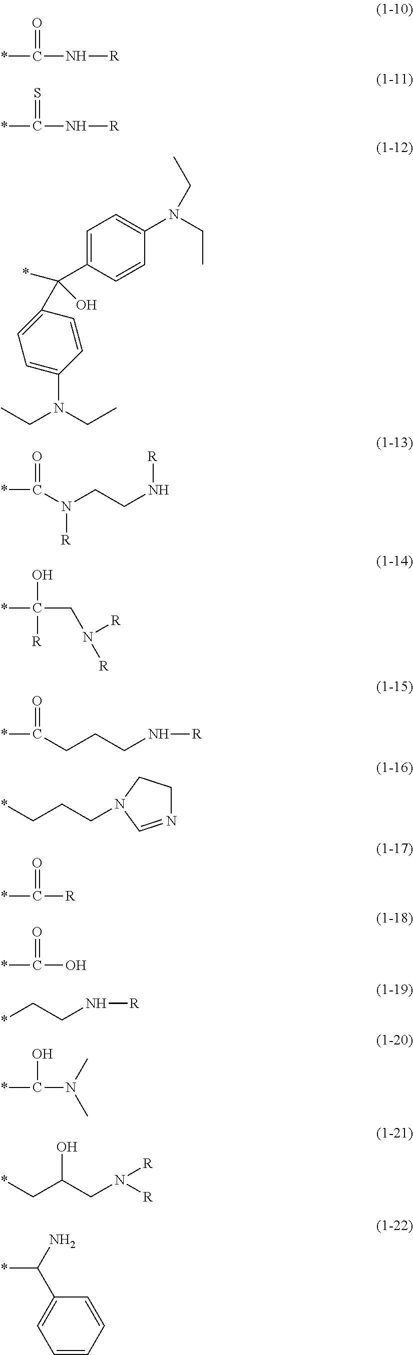

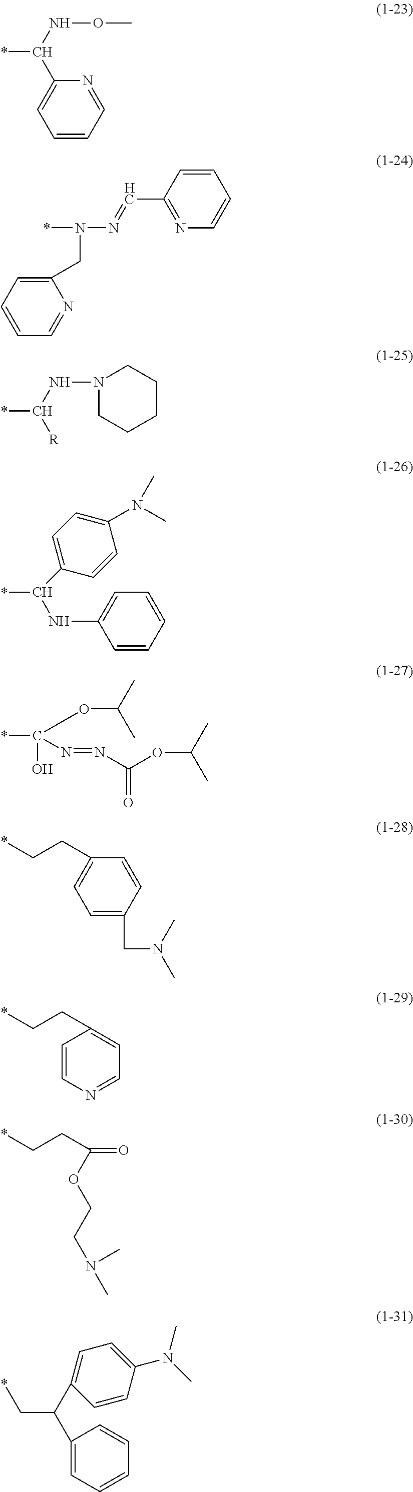

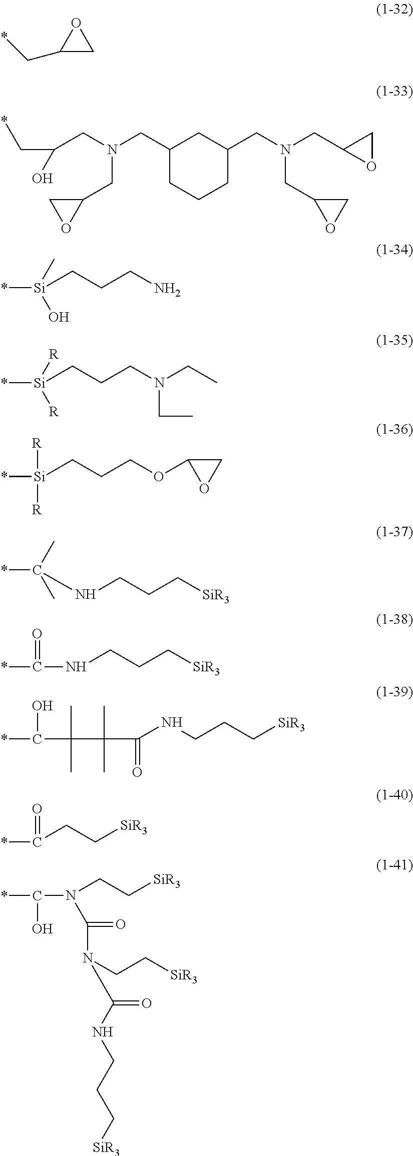

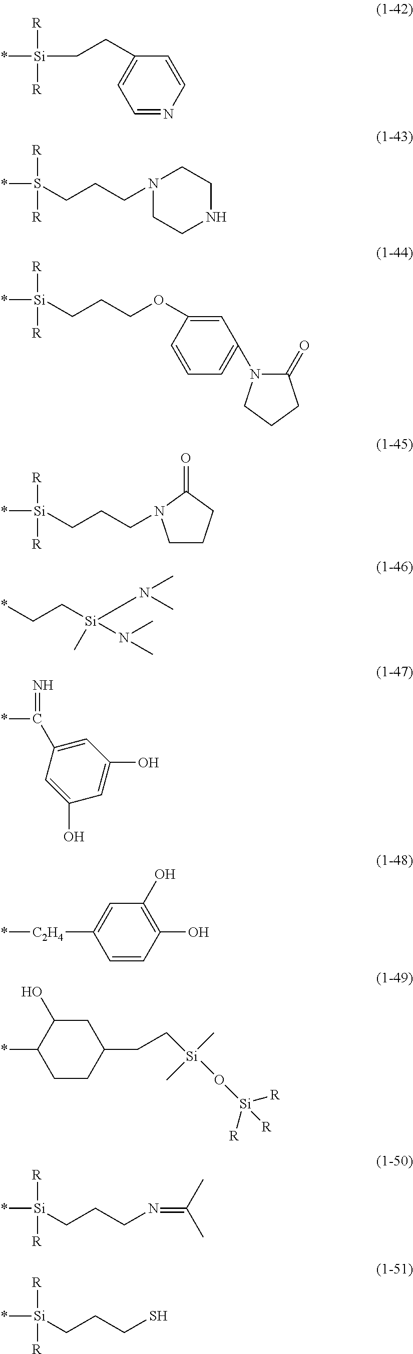

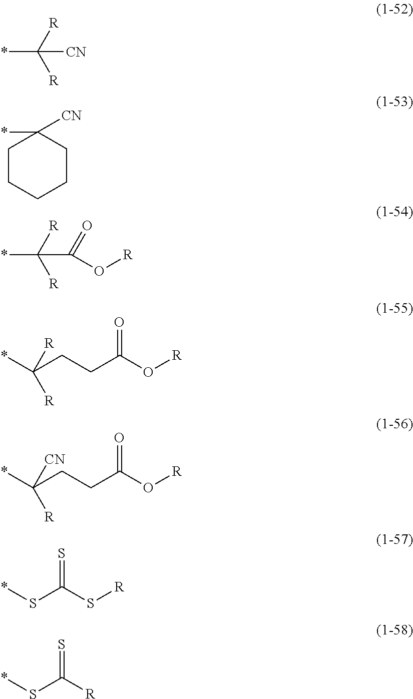

In the above formulae (1-1) to (1-58), R represents a hydrogen atom or a monovalent organic group, and preferably represents a hydrogen atom or a monovalent hydrocarbon group; and “*” denotes a site that binds to a carbon atom at the end of the main chain of the polymer in the block copolymer (A).

Of these, as the group represented by the above formula (1), the groups represented by the above formulae (1-1) to (1-7), and the groups represented by the above formulae (1-57) and (1-58) are preferred, and the groups represented by the above formulae (1-2), (1-3) and (1-4) are more preferred.

The block having the group (α) in the block copolymer (A) may be the block (I), the block (II) or other block, and the block (I) or the block (II) is preferred and the block (II) is more preferred. Due to having the structure in which the group (α) is bound to the end of the main chain of these blocks, the composition for pattern formation enables a pattern having a finer microdomain structure to be formed.

### Synthesis Method of Block Copolymer (A)

The block copolymer (A) may be synthesized by living anionic polymerization, living radical polymerization or the like. Of these, living anionic polymerization is preferred which enables formation of the block copolymer comparatively easily in a case in which a polymer having an arbitrary end structure is to be obtained. For example, the block copolymer (A) may be synthesized by linking the block (I), the block (II) and as needed a block other than these blocks in a desired order while permitting formation, and as needed, treating thus resultant polymerization end with an arbitrary end treatment agent to introduce the group (α) such as a group represented by the above formula (1). Alternatively, since the environment for the polymerization is usually in a neutral region, living radical polymerization that enables a stable synthesis may be also suitably used.

For example, in a case in which the block copolymer (A) that is constituted with the block (I) and the block (II) is synthesized by anionic polymerization, the block (I) is prepared first by polymerizing a monomer for forming the block (I) using an anionic polymerization initiator in an appropriate solvent. Next, a compound such as diphenylethylene is introduced so as to link to the block (I). In the presence of a lithium ion or the like, a monomer for forming the block (II) is similarly polymerized to prepare the block (II). In this procedure, R⁵ in the above formula (II) may be protected beforehand, and the protecting group may be dissociated after the polymerization. Thereafter, the polymerization reaction may be stopped by subjecting to a treatment with methanol, or the group (α) such as the group represented by the above formula (1) may be introduced to the end of the main chain of the copolymer by subjecting to a treatment with an end treatment agent such as 1,2-butylene oxide in place of methanol.

Examples of the solvent for use in the anionic polymerization include:

alkanes such as n-pentane, n-hexane, n-heptane, n-octane, n-nonane and n-decane;

cycloalkanes such as cyclohexane, cycloheptane, cyclooctane, decalin and norbornane;

aromatic hydrocarbons such as benzene, toluene, xylene, ethylbenzene and cumene;

halogenated hydrocarbons such as chlorobutanes, bromohexanes, dichloroethanes, hexamethylene dibromide and chlorobenzene;

saturated carboxylate esters such as ethyl acetate, n-butyl acetate, i-butyl acetate and methyl propionate;

ketones such as acetone, 2-butanone, 4-methyl-2-pentanone and 2-heptanone;

ethers such as tetrahydrofuran, diethoxyethanes and diethoxyethanes;

alcohols such as methanol, ethanol, 1-propanol, 2-propanol and 4-methyl-2-pentanol, and the like.

These solvents may be used either alone, or two or more types thereof may be used in combination.

The reaction temperature in the anionic polymerization may be appropriately predetermined in accordance with the type of the initiator, and the reaction temperature is typically −150° C. to 50° C., and preferably −80° C. to 40° C. The reaction time period is typically 5 min to 24 hrs, and preferably 20 min to 12 hrs.

Examples of the initiator for use in the anionic polymerization include alkyllithiums, alkyl magnesium halides, naphthalene sodium, alkylated lanthanoid compounds, and the like. Of these, alkyllithiums are preferred.

An exemplary procedure for the end treatment may be to execute a reaction as shown in the following scheme, and the like. More specifically, the end treatment agent such as 1,2-butylene oxide is added to a polymerization end of a resultant block copolymer to modify the end, and then a demetallation treatment with an acid or the like is carried out, whereby a block copolymer having, for example the group (α) such as the group represented by the above formula (1) at the end can be obtained.

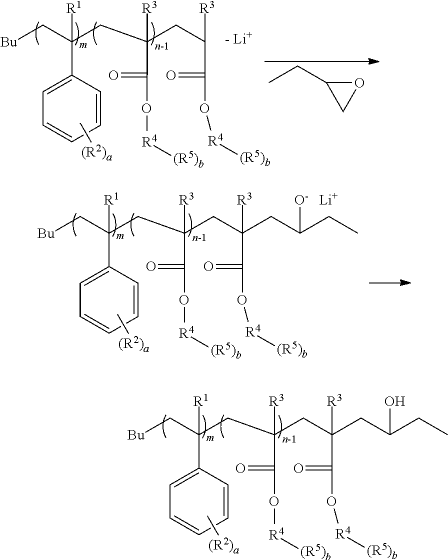

In the above scheme, R¹ to R⁵, a, b, m and n are as defined in the above formulae (I) and (II).

Examples of the end treatment agent include:

epoxy compounds such as 1,2-butylene oxide, butyl glycidyl ether, 2-ethylhexyl glycidyl ether, propylene oxide, ethylene oxide and epoxyamine;

nitrogen-containing compounds such as isocyanate compounds, thioisocyanate compounds, imidazolidinone, imidazole, aminoketone, pyrrolidone, diethylaminobenzophenone, nitrile compounds, aziridine, formamide, epoxyamine, benzylamine, oxime compounds, azine, hydrazone, imine, azocarboxylate esters, aminostyrene, vinylpyridine, aminoacrylate, aminodiphenylethylene and imide compounds;

silane compounds such as alkoxysilane, aminosilane, ketoiminosilane, isocyanatosilane, siloxane, glycidylsilane, mercaptosilane, vinylsilane, epoxysilane, pyridylsilane, piperazylsilane, pyrrolidonesilane, cyanosilane and silane isocyanate;

tin halides, silicon halides, carbon dioxide, and the like.

Of these, epoxy compounds are preferred, and 1,2-butylene oxide, butyl glycidyl ether, 2-ethylhexyl glycidyl ether and propylene oxide are more preferred.

Alternatively, the block copolymer (A) can be synthesized also by living radical polymerization such as, for example, RAFT polymerization.

For example, when the block copolymer (A) as a diblock copolymer constituted with the block (I) and block the (II) is synthesized by RAFT polymerization, the block (II) is first prepared by polymerizing the monomer for forming the block (II) in an appropriate solvent using a radical polymerization initiator and a chain transfer agent (RAFT agent). Next, after a residual monomer is eliminated by a reprecipitation technique or the like, a radical polymerization initiator and a solvent that are appropriate are again charged to allow the monomer for forming the block (I) to be polymerized, whereby the diblock polymer is synthesized. Thereafter, a residual monomer is eliminated by the reprecipitation technique or the like to obtain the block copolymer (A).

Thereafter, the end formed from the RAFT agent may be either removed by heating in an appropriate solvent together with the radical polymerization initiator, or directly used without the elimination.

Examples of the solvent for use in the RAFT polymerization include solvents similar to those exemplified as the solvent for use in the above anionic polymerization, and the like.

The reaction temperature in the RAFT polymerization may be appropriately predetermined in accordance with the type of the initiator, and the reaction temperature is typically 30° C. to 150° C., and preferably 40° C. to 120° C. The reaction time period is typically 2 hrs to 48 hrs, and preferably 3 hrs to 36 hrs.

Examples of the initiator for use in the RAFT polymerization include azo initiators such as azobisisobutyronitrile and methyl azobisisobutyrate, organic peroxides such as benzoyl peroxide, and the like, and an azo initiator is preferably used.

The block copolymer (A) obtained according to the various methods described above is preferably recovered by a reprecipitation technique. More specifically, after completing the reaction, the reaction liquid is charged into a reprecipitation solvent to recover the intended copolymer in the form of powder. As the reprecipitation solvent, an alcohol, an alkane and the like may be used either alone or as a mixture of two or more thereof. As an alternative to the reprecipitation technique, a liquid separating operation, column chromatography operation, ultrafiltration operation or the like may be employed to recover the copolymer through eliminating low molecular components such as monomers and oligomers.

The weight average molecular weight (Mw) as determined by gel permeation chromatography (GPC) of the block copolymer (A) is preferably 2,000 to 150,000, more preferably 3,000 to 120,000, and still more preferably 4,000 to 100,000. When the block copolymer (A) has Mw falling within the above range, the composition for pattern formation enables a pattern having a finer microdomain structure to be formed.

The ratio (Mw/Mn) of Mw to the number average molecular weight (Mn) of the block copolymer (A) is typically 1 to 5, preferably 1 to 3, more preferably 1 to 2, still more preferably 1 to 1.5, and particularly preferably 1 to 1.2. When the ratio Mw/Mn falls within such a range, the composition for pattern formation enables a pattern having a finer and favorable microdomain structure to be formed.

Mw and Mn are values determined by gel permeation chromatography (GPC) using: GPC columns (G2000 HXL×2, G3000 HXL×1, G4000 HXL×1, all manufactured by Tosoh Corporation); a differential refractometer as a detector; and mono-dispersed polystyrene as a standard, under analytical conditions involving a flow rate of 1.0 mL/min, with an elution solvent of tetrahydrofuran, the sample concentration of 1.0% by mass, and the amount of an injected sample of 100 μL, at a column temperature of 40° C.

### (B) Solvent

The composition for pattern formation usually contains (B) a solvent. Examples of the solvent include those similar to the solvents exemplified in connection with, for example, the solvent for use in the synthesis method of the block copolymer (A). Of these, propylene glycol monomethyl ether acetate (PGMEA) is preferred. It is to be noted that these solvents (B) may be used either alone, or two or more types thereof may be used in combination.

### Surfactant

The composition for pattern formation may further contain a surfactant. Due to containing the surfactant, the composition for pattern formation enables coating properties onto the substrate and the like to be improved.

### Preparation Method of the Composition for Pattern Formation

The composition for pattern formation may be prepared by, for example, mixing the block copolymer (A), the surfactant and the like in the solvent (B) at a predetermined ratio. Furthermore, the composition for pattern formation may be prepared and used in a state being dissolved or dispersed in an appropriate solvent.

### Pattern-Forming Method

The pattern-forming method according to an another embodiment of the present invention includes the steps of:

providing a directed self-assembling film having a phase separation structure on a substrate using the composition for pattern formation of the embodiment of the present invention (hereinafter, may be also referred to as “directed self-assembling film-providing step”); and

removing a part of phases of the directed self-assembling film (hereinafter, may be also referred to as “removing step”).

In addition, it is preferred that the pattern-forming method according to the another embodiment of the present invention further includes before the directed self-assembling film-providing step: providing an underlayer film on the substrate (hereinafter, may be also referred to as “underlayer film-providing step”); and forming a prepattern on the underlayer film (hereinafter, may be also referred to as “prepattern-forming step”), and in the directed self-assembling film-providing step, the directed self-assembling film is provided in a region compartmentalized by the prepattern on the underlayer film, and that the method further includes after the directed self-assembling film-providing step, a step of removing the prepattern (hereinafter, may be also referred to as “prepattern-removing step”).

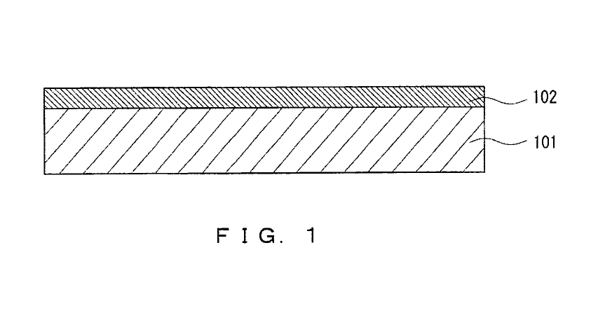

Moreover, it is preferred that the method further includes after the removing step, the step of etching the substrate (and as needed, the underlayer film) using the formed pattern as a mask (hereinafter, may be also referred to as “etching step”). Each step will be described in detail below. Note that each step will be explained with reference to FIGS. 1 to 5.

### Underlayer Film-Providing Step

According to this step, a composition for forming an underlayer film is used to provide an underlayer film on the substrate. Thus, as shown in FIG. 1, a substrate having an underlayer film can be obtained which includes the underlayer film 102 provided on the substrate 101, and the directed self-assembling film is provided on the underlayer film 102. The phase separation structure (microdomain structure) included in the directed self-assembling film is altered by not only an interaction between each block of the block copolymer (A) contained in the composition for pattern formation but also an interaction with the underlayer film 102; therefore, the structure can be easily controlled by virtue of having the underlayer film 102, and thus a desired pattern can be obtained. Moreover, when the directed self-assembling film is thin, a transfer process of the pattern can be improved owing to having the underlayer film 102.

As the substrate 101, for example, a conventionally well-known substrate such as a silicon wafer, a wafer coated with aluminum or the like may be used.

Also, as the composition for forming an underlayer film, a conventionally well-known organic material for forming an underlayer film may be used.

Although the procedure for providing the underlayer film 102 is not particularly limited, an exemplary procedure may involve, for example, coating by a well-known method such as a spin coating method on the substrate 101 to give a coating film, followed by exposure and/or heating to permit curing, and the like. Examples of the radioactive ray which may be employed for the exposure include visible light rays, ultraviolet rays, far ultraviolet rays, X-rays, electron beams, γ-rays, molecular beams, ion beams, and the like.

Moreover, the temperature employed during heating the coating film is not particularly limited, and the temperature is preferably 90° C. to 550° C., more preferably 90° C. to 450° C., and still more preferably 90° C. to 300° C. Furthermore, the film thickness of the underlayer film 102 is not particularly limited, and the film thickness is preferably 50 nm to 20,000 nm, and more preferably 70 nm to 1,000 nm. Still further, the underlayer film 102 preferably includes an SOC (Spin on carbon) film.

### Prepattern-Forming Step

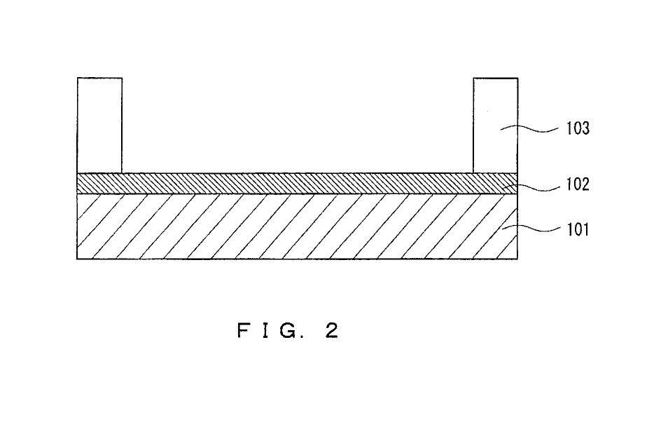

According to this step, as shown in FIG. 2, a prepattern 103 is formed on the underlayer film 102 using a composition for prepattern formation. The prepattern 103 enables a pattern configuration obtained by phase separation of the composition for pattern formation to be controlled, and thus a more desired fine pattern can be formed. More specifically, among the blocks included in the block copolymer (A) contained in the composition for pattern formation, blocks having a higher affinity to lateral faces of the prepattern form the phases along the prepattern, whereas blocks having a lower affinity form the phases at positions away from the prepattern. Accordingly, a more desired pattern can be formed. In addition, according to the material, size, shape, etc., of the prepattern, the structure of the pattern obtained by obtained by phase separation of the composition for pattern formation can be more finely controlled. It is to be noted that the prepattern may be appropriately selected depending on the pattern intended to be finally formed, and, for example, a line-and-space pattern, a hole pattern and the like may be employed.

As the method for forming the prepattern 103, those similar to well-known resist pattern-forming methods may be used. In addition, a conventional resist composition may be used as the composition for prepattern formation. In a specific method for forming the prepattern 103, for example, a chemical amplification resist composition such as ARX2928JN (manufactured by JSR Corporation) is used to provide a resist film on the underlayer film 102 by coating. Next, an exposure is carried out by irradiating a desired region of the resist film with a radioactive ray through a mask of a specific pattern. Examples of the radioactive ray include ultraviolet rays, far ultraviolet rays, X-rays, charged particle rays, and the like. Of these, far ultraviolet rays such as ArF excimer laser beams and KrF excimer laser beams are preferred, and ArF excimer laser beams are more preferred. Also, the exposure may employ a liquid immersion medium for liquid immersion lithography. Subsequently, post exposure baking (PEB) is carried out, followed by development using an alkaline developer solution, an organic solvent developer solution or the like, whereby a desired prepattern 103 can be formed.

It is to be noted that the surface of the prepattern 103 may be subjected to a hydrophobilization treatment or a hydrophilization treatment. In specific treatment methods, a hydrogenation treatment including exposing to hydrogen plasma for a certain time period, and the like may be adopted. An increase of the hydrophobicity or hydrophilicity of the surface of the prepattern 103 enables directed self-assembling of the composition for pattern formation to be accelerated.

### Directed Self-Assembling Film-Providing Step

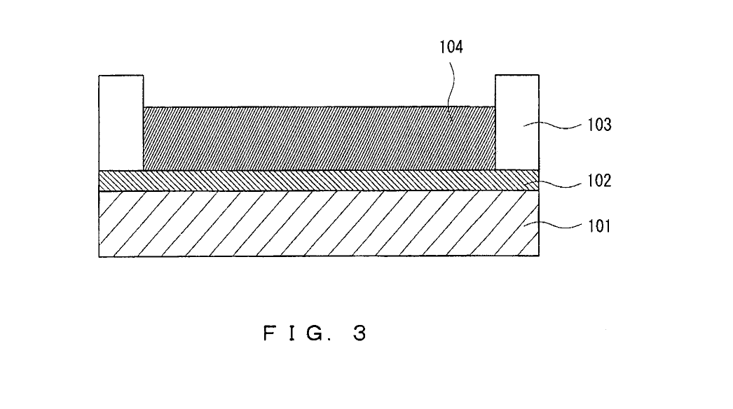

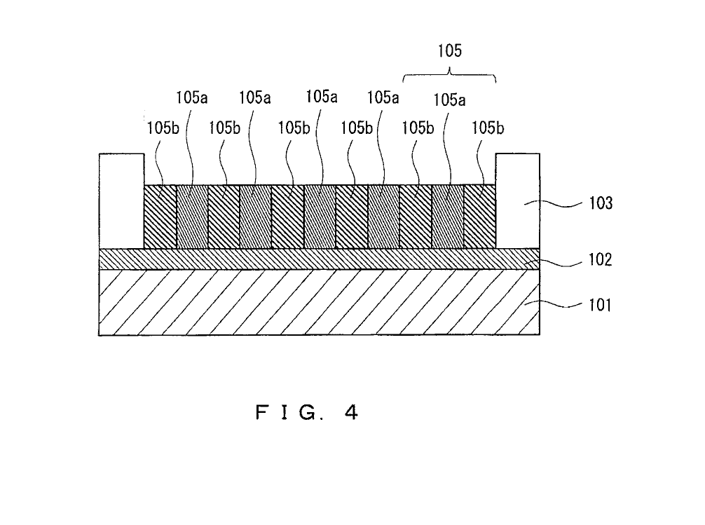

In this step, a directed self-assembling film having a phase separation structure is provided on the substrate using the composition for pattern formation. In the case in which the underlayer film and the prepattern are not used, the composition for pattern formation is directly coated on the substrate to give a coating film, whereby the directed self-assembling film having a phase separation structure is provided. Moreover, in a case in which the underlayer film and the prepattern are used, as shown in FIGS. 3 and 4, the composition for pattern formation is coated on the region surrounded by the prepattern 103 on the underlayer film 102 to give the coating film 104, whereby a directed self-assembling film 105 having a phase separation structure having an interface that is substantially perpendicular to the substrate 101 is provided on the underlayer film 102 formed on the substrate 101. More specifically, coating on the substrate the composition for pattern formation containing the block copolymer (A) having two or more types of blocks that are not compatible with each other, followed by annealing and the like allows blocks having identical properties to be assembled with one another to spontaneously form an ordered pattern, and thus enables directed self-assembling, as generally referred to, to be accelerated. Accordingly, a directed self-assembling film having a phase separation structure such as a sea-island structure, a cylinder structure, a co-interconnected structure or a lamellar structure can be formed, and these phase separation structures preferably have an interface substantially perpendicular to the substrate 101. In this step, by using the composition for pattern formation, occurrence of phase separation is facilitated, and therefore, formation of a finer phase separation structure (microdomain structure) is enabled.

When the prepattern is formed as described above, the phase separation structure is preferably formed along the prepattern, and the interface formed by the phase separation is preferably substantially parallel to the lateral face of the prepattern. For example, in a case in which an affinity of the block (I) of the block copolymer (A) to the prepattern 103 is high, the phases (105b) of the block (I) are linearly formed along the prepattern 103, and adjacent thereto, phases (105a) of the blocks (II) and phases (105b) of the block (I) are alternately arranged in this order to form a lamellar phase separation structure or the like. It is to be noted that the phase separation structure formed in this step is configured with a plurality of phases, and the interface formed by these phases is substantially perpendicular, in general; however, the interface per se may not necessarily be clear. In addition, the resultant phase separation structure can be more strictly controlled by way of a ratio of the length of each block chain (chain of block (I), chain of block (II), etc.) in molecules of the block copolymer (A), the length of the molecule of the block copolymer (A), the prepattern, the underlayer film, and the like; consequently, a more desired fine pattern can be obtained.

Although the procedure for providing the coating film 104 by coating the composition for pattern formation on the substrate is not particularly limited, for example, a procedure in which the composition for pattern formation employed is coated by spin coating or the like, and the like may be involved. Accordingly, filling with the composition for pattern formation between the prepattern 103 on the underlayer film 102 is executed.

The annealing process may include, for example, heating at a temperature of 80° C. to 400° C. in an oven, on a hot plate, etc., and the like. The annealing time period is typically 1 min to 120 min, and preferably 5 min to 90 min. The film thickness of the directed self-assembled film 105 thus obtained is preferably 0.1 nm to 500 nm, and more preferably 0.5 nm to 100 nm.

### Removing Step

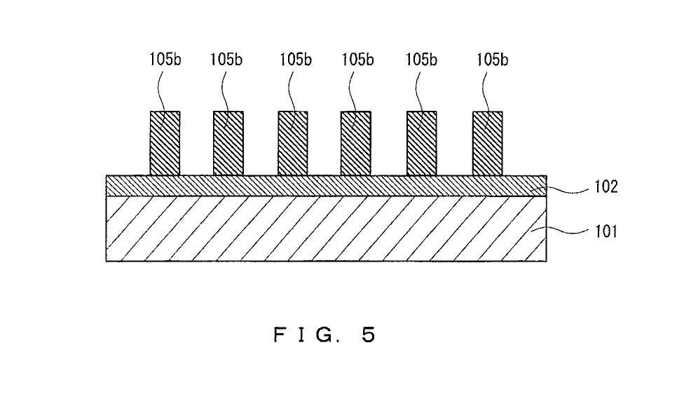

In this step, as shown in FIGS. 4 and 5, a part of block phases (for example, 105a) of phases of the phase separation structure, included in the directed self-assembling film 105 are removed. For example, the phases 105a of the block (II) can be removed with an etching treatment by making use of the difference in the etching rate of each phase generated by phase separation by way of the directed self-assembling. A state after removing the phases 105a of the block (II) of the phase separation structure, and the prepattern 103 as described later, is shown in FIG. 5. It is to be noted that prior to the etching treatment, irradiation with a radioactive ray may be conducted as needed. As the radioactive ray, in a case in which the phases to be removed by etching are phases of the block (II), a radioactive ray of 254 nm may be used. The irradiation with the radioactive ray results in decomposition of the phases of the block (II), whereby etching can be facilitated.

As the procedure for removing a part of the block phases (for example, the phases of the 105a of the block (II)) in the phase separation structure included in the directed self-assembling film 105, well-known procedures e.g., reactive ion etching (RIE) such as chemical dry etching and chemical wet etching; physical etching such as sputter etching and ion beam etching, and the like may be exemplified. Of these, reactive ion etching (RIE) is preferred, and in particular, chemical dry etching using CF₄, O₂ gas or the like, and chemical wet etching (wet development) using an etching solution, a liquid such as an organic solvent or hydrofluoric acid, are more preferred. Examples of the organic solvent include alkanes such as n-pentane, n-hexane and n-heptane, cycloalkanes such as cyclohexane, cycloheptane and cyclooctane, saturated carboxylate esters such as ethyl acetate, n-butyl acetate, i-butyl acetate and methyl propionate, ketones such as acetone, 2-butanone, 4-methyl-2-pentanone and 2-heptanone, alcohols such as methanol, ethanol, 1-propanol, 2-propanol and 4-methyl-2-pentanol, and the like. These organic solvents may be used either alone, or two or more types thereof may be used in combination.

### Prepattern-Removing Step

In this step, the prepattern 103 is removed as shown in FIGS. 4 and 5. Removal of the prepattern 103 enables a finer and complicated pattern to be formed. It is to be noted that with respect to the procedure for removing the prepattern 103, the above description in connection with the procedure for removing a part of the block phases 105a of the phase separation structure may be employed. Also, this step may be carried out concomitantly with the removing step, or may be carried out before or after the removing step.

### Etching Step

In this step, after the removing step, using the pattern configured with the phases 105b of the block (I) that are a part of the block phases of the residual phase separation film as a mask, the underlayer film and the substrate are etched to permit patterning. After completion of the patterning onto the substrate, the phases used as a mask are removed from the substrate by a dissolving treatment or the like, whereby a patterned substrate (pattern) can be finally obtained. As the procedure for the etching, the procedure similar to those in the removing step may be employed, and the etching gas and the etching solution may be appropriately selected according to the materials of the underlayer film and the substrate. For example, in a case in which the substrate is a silicon material, a gas mixture of chlorofluorocarbon-containing gas and SF₄, or the like may be used. Also, in a case in which the substrate is a metal film, a gas mixture of BCl₃ and Cl₂, or the like may be used. It is to be noted that the pattern obtained according to the pattern-forming method is suitably used for semiconductor elements and the like, and further the semiconductor elements are widely used for LED, solar cells and the like.

### EXAMPLES

Hereinafter, the present invention will be explained more specifically by way of Examples, but the present invention is not limited to these Examples. Methods of the determination of various types of physical property values are shown below.

### Weight Average Molecular Weight (Mw) and Number Average Molecular Weight (Mn)

The Mw and the Mn of the polymer were determined by gel permeation chromatography (GPC) using GPC columns (G2000 HXL×2, G3000 HXL×1, G4000 HXL×1) manufactured by Tosoh Corporation under the following conditions.

eluent: tetrahydrofuran (manufactured by Wako Pure Chemical Industries, Ltd.)

column temperature: 40° C.

flow rate: 1.0 mL/min

sample concentration: 1.0% by mass

amount of injected sample: 100 μL

detector: differential refractometer

standard substance: mono-dispersed polystyrene

### ¹³C-NMR Analysis:

The ¹³C-NMR analysis was carried out using JNM-EX400 manufactured by JEOL, Ltd., with DMSO-d₆ for use as a solvent for measurement. The percentage content of each structural unit in the polymer was calculated from each area ratio of the peak corresponding to each structural unit on the spectrum obtained by ¹³C-NMR.

### Synthesis of Block Copolymer (A)

### Synthesis Example 1

Into a reaction vessel having an internal volume of 0.5 L which had been purged with nitrogen was charged 200 g of tetrahydrofuran, and thereto were added 0.27 g of a 1 N cyclohexane solution containing 0.047 g of s-BuLi (s-butyllithium) as an initiator and 10 g of styrene. Polymerization was carried out at −70° C. to prepare the block (I). After ascertaining completion of the polymerization, 0.40 g of diphenylethylene and 0.063 g of lithium chloride were added. Furthermore, 10 g of trimethylsiloxyethyl methacrylate was added to the reaction vessel, and the polymerization was carried out to prepare the block (II). After ascertaining completion of the polymerization, a predetermined amount of methanol was added to stop the polymerization. The progress of the polymerization was chased through determination of the residual solid content by the measurement after heating the polymerization reaction solution sampled into an aluminum plate on a hot plate at 150° C. As a result of determination on GPC, a finally obtained block polymer had Mw of 36,800, and Mw/Mn was 1.11.

### Synthesis Examples 2 to 8

Diblock copolymers (A-2) to (A-6), and (a-1) and (a-2) were synthesized in a similar manner to Synthesis Example 1 except that the amount of the 1 N s-BuLi solution in cyclohexane used, and the types of the monomers for forming the block (I) and the block (II) were as shown in Table 1. The percentage content of the structural unit constituting the block (I) and the block (II) in each block copolymer, and Mw and Mw/Mn are shown in Table 1.

TABLE 1

| | | Amount of 1 N | | | | | | |
|---|---|---|---|---|---|---|---|---|
| | (A) | s-BuLi solution | | | Percentage content of | | | |
| | Com- | in cyclohexane | Monomer | | structural unit (mol %) | | | |
| | ponent | (g) | block (I) | block (II) | block (I) | block (II) | Mw | Mw/Mn |
| Synthesis | A-1 | 0.27 | styrene | trimethylsiloxyethyl | 50.1 | 49.9 | 36,800 | 1.11 |
| Example 1 | | | | methacrylate | | | | |
| Synthesis | A-2 | 0.55 | styrene | trimethylsiloxyethyl | 50.3 | 49.7 | 14,000 | 1.09 |
| Example 2 | | | | methacrylate | | | | |
| Synthesis | A-3 | 0.15 | styrene | trimethyl acrylate siloxyethyl | 49.8 | 50.2 | 81,000 | 1.15 |
| Example 3 | | | | | | | | |
| Synthesis | A-4 | 0.29 | styrene | trimethylsiloxyethyl | 50.5 | 49.5 | 45,000 | 1.14 |
| Example 4 | | | | methacrylate | | | | |
| Synthesis | A-5 | 0.50 | styrene | trimethyl acrylate siloxyethyl | 50.3 | 49.7 | 21,000 | 1.08 |
| Example 5 | | | | | | | | |
| Synthesis | a-1 | 0.18 | styrene | isoprene | 50.0 | 50.0 | 79,000 | 1.14 |
| Example 6 | | | | | | | | |
| Synthesis | a-2 | 0.45 | styrene | methyl methacrylate | 50.2 | 49.8 | 29,000 | 1.10 |
| Example 7 | | | | | | | | |

### Preparation of Composition for Pattern Formation

### Examples 1 to 5, and Comparative Examples 1 and 2

The diblock copolymers were each dissolved in propylene glycol monomethyl ether acetate (PGMEA) to prepare 1% by mass solutions. These solutions were filtered through a membrane filter having a pore size of 200 nm to prepare compositions for pattern formation, and patterns were formed according to the following method.

### Pattern-Forming Method

On a 12-inch silicon wafer was spin-coated a composition for forming an organic underlayer film containing a crosslinking agent using CLEAN TRACK ACT12 (manufactured by Tokyo Electron Limited), followed by baking at 205° C. for 60 sec to provide an underlayer film having a film thickness of 77 nm. Next, after an ArF resist composition containing an acid-labile resin, a photo acid generating agent and an organic solvent was spin-coated on the underlayer film, prebaking (PB) was carried out at 120° C. for 60 sec to provide a resist film having a film thickness of 60 nm. Then, the resist film was exposed through a mask pattern using ArF Immersion Scanner (NSR S610C, manufactured by Nikon Corporation), under an optical condition involving NA of 1.30, CrossPole, and σ of 0.977/0.78. Thereafter, PEB was carried out at 115° C. for 60 sec, and then a development with a 2.38% by mass aqueous tetramethylammonium hydroxide solution was carried out at 23° C. for 30 sec, followed by washing with water and drying gave a prepattern with holes having a diameter of 55 nm/a pitch of 110 nm. Subsequently, the prepattern was irradiated with an ultraviolet light of 254 nm under a condition of 150 mJ/cm², followed by baking at 170° C. for 5 min to obtain a silicon wafer substrate on which the underlayer film and the prepattern are formed.

Each composition for pattern formation was coated on the obtained silicon wafer substrate so as to give a thickness of the resulting film of 30 nm, and heated at 250° C. for 5 min to cause phase separation, whereby a microdomain structure was formed. Furthermore, after irradiation with a radioactive ray of 254 nm at 3,000 mJ/cm², immersion in a solution of methyl isobutyl ketone (MIBK)/2-propanol (IPA)=2/8 (mass ratio) for 5 min allowed the phases of the block (II) to be removed, whereby a pattern was formed.

### Evaluations

The pattern formed as described above was observed using a line-width measurement SEM (S-4800, manufactured by Hitachi, Ltd.), and the width of a groove portion that looked white was measured to determine a width (nm) of the microdomain structure. The evaluation was made to be “favorable” when the width (nm) of the microdomain structure was no greater than 30 nm, whereas the evaluation was made to be “unfavorable” when the width (nm) of the microdomain structure was greater than 30 nm or when formation of the microdomain structure failed. The results of evaluations are shown in Table 2. It is to be noted that “-” in Table 2 denotes a failure of the measurement of the width of the microdomain structure since a microdomain structure was not formed.

TABLE 2

| | (A) | (B) | Width of microdomain |
|---|---|---|---|
| | Component | Solvent | structure (nm) |
| Example 1 | A-1 | PGMEA | 16.5 |
| Example 2 | A-2 | PGMEA | 8.4 |
| Example 3 | A-3 | PGMEA | 23.4 |
| Example 4 | A-4 | PGMEA | 17.1 |
| Example 5 | A-5 | PGMEA | 9.5 |
| Comparative | a-1 | PGMEA | — |
| Example 1 | | | |
| Comparative | a-2 | PGMEA | — |
| Example 2 | | | |

As shown in Table 2, it was revealed that a sufficiently fine microdomain structure was obtained when the compositions for pattern formation of Examples were used. According to the compositions for pattern formation of Comparative Examples, phase separation during pattern formation was less likely to occur, and formation of the microdomain structure failed.

According to the embodiments of the present invention, a composition for pattern formation enabling a pattern having a sufficiently fine microdomain structure to be formed, and a pattern-forming method in which the same is used can be provided. Therefore, the composition for pattern formation and the pattern-forming method according to the embodiments of the present invention are suitably used in lithography processes in manufacture of various types of electronic devices such as semiconductor devices and liquid crystal devices for which further miniaturization has been demanded.

Obviously, numerous modifications and variations of the present invention are possible in light of the above teachings. It is therefore to be understood that within the scope of the appended claims, the invention may be practiced otherwise than as specifically described herein.

1. A composition for pattern formation comprising:
a block copolymer comprising a block represented by formula (I) and a block represented by formula (II): 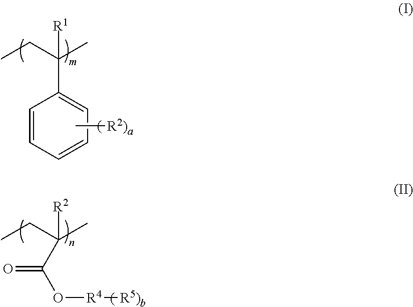
wherein, in the formulae (I) and (II), R¹ and R³ each independently represent a hydrogen atom, a methyl group, a fluorine atom or a trifluoromethyl group; R² represents a monovalent organic group; R⁴ represents a hydrocarbon group having a valency of (1+b) and having 1 to 5 carbon atoms; R⁵ represents a monovalent group having a hetero atom; m and n are each independently an integer of 10 to 5,000; a is an integer of 0 to 5; and b is an integer of 1 to 3, wherein in a case in which a and b are each 2 or greater, a plurality of R²s are each identical or different with each other, and a plurality of R⁵s are each identical or different with each other.

2. The composition for pattern formation according to claim 1, further comprising a solvent.

3. The composition for pattern formation according to claim 1, wherein R⁵ in the formula (II) represents —OSiR⁶₃, —SiR⁶₃, —OH, —NH₂, —OSiH₃, —COOH, —COOR⁶ or —COR⁶, wherein R⁶ represents a monovalent hydrocarbon group having 1 to 5 carbon atoms or a monovalent silicon-containing group having 1 to 5 silicon atoms, wherein in a case in which R⁶ is present in a plurality of number, a plurality of R⁶s are identical or different.

4. The composition for pattern formation according to claim 1, wherein the block copolymer comprises a hetero atom-containing group on at least one end of a main chain of the block copolymer.

5. A pattern-forming method comprising:
applying the composition according to claim 1 directly or indirectly on a substrate such that a directed self-assembling film comprising a phase separation structure is provided, the phase separation structure comprising a plurality of phases each of which is separately arranged; and
removing a part of the plurality of phases of the directed self-assembling film such that a pattern is formed.

6. The pattern-forming method according to claim 5,
wherein the pattern-forming method further comprises before providing the directed self-assembling film:
providing an underlayer film on the substrate; and
forming a prepattern on the underlayer film,
wherein the directed self-assembling film is provided in a region compartmentalized by the prepattern on the underlayer film, and
wherein the pattern-forming method further comprises after providing the directed self-assembling film:
removing the prepattern.

7. The pattern-forming method according to claim 5, wherein the pattern obtained is a line-and-space pattern or a hole pattern.
